(19) United States
(12) Patent Application Publication
(10) Pub. No.: US 2012/0031971 A1
(43) Pub. Date: Feb. 9, 2012

(54) STORAGE RACK WITH AUTOMATIC TAG READING DEVICE AND PRODUCT FOR PLACEMENT IN SUCH A STORAGE RACK

(75) Inventors: Georges FOLCKE, Paris (FR); Eric GOUT, Igny (FR); Christophe RAOULT, Guyancourt (FR)

(73) Assignee: WINSTEAD ASSETS LIMITED, Road Town (VG)

(21) Appl. No.: 13/276,013

(22) Filed: Oct. 18, 2011

Related U.S. Application Data
(63) Continuation of application No. 12/064,458, filed on Sep. 2, 2008, now abandoned.

(30) Foreign Application Priority Data
Aug. 23, 2005 (FR) 0508697
Aug. 23, 2005 (FR) 0508698
Aug. 23, 2005 (FR) 0508700

(51) Int. Cl. G06Q 90/00; G06K 19/077

(52) U.S. Cl. 235/385; 235/492

(57) ABSTRACT

A product that has the shape of a rectangular parallelepiped comprises at least one metallic part with at least one narrow edge. The product further comprises an electronic tag having an antenna positioned substantially perpendicular to a narrow edge of said at least one metallic part. A paper label is positioned on at least one of the following sides of the product: (i) a side opposite to a side of the product bearing said electronic tag, and (ii) a side of the product adjacent to a side of the product bearing said electronic tag on one of its small sides.

### CROSS-REFERENCE

The present application is a continuation of U.S. patent application Ser. No. 12/064,458, filed Aug. 22, 2006, and entitled ‘Storage Rack with Automatic Tag Reading Device and Information Processing System Comprising such a Storage Rack’, the entirety of which is incorporated herein by reference.

### TECHNICAL FIELD

This invention relates to a storage rack with automatic tag reading device and a product for placement in such a storage rack. The invention may be used, for example, for storage of hospital supplies, medical products and medications and replenishment of such stocks.

### BACKGROUND

The use of electronic tags, such as RFID (RadioFrequency IDentification) tags poses numerous problems when they are in the presence of metallic parts, such as metallic cans used for the storage of objects, liquids or food. The electromagnetic field used to read these electronic tags is in fact disturbed by the metallic parts, impairing, if not preventing, communication with the electronic tag.

### SUMMARY

This invention aims to overcome these disadvantages.

According to a an aspect of the invention, a product having the shape of a rectangular parallelepiped comprises at least one metallic part with at least one narrow edge, an electronic tag having one antenna positioned substantially perpendicular to a narrow edge of said at least one metallic part, and a paper label positioned on at least one of the following sides of the product: (i) a side opposite to a side of the product bearing said electronic tag, and (ii) a side of the product adjacent to a side of the product bearing said electronic tag on one of its small sides.

When the product is stored, in a stack or vertically in a cabinet, the user is encouraged to position it so that its paper label is visible. Due to this position, the electronic tag is positioned toward an antenna positioned so as to read the electronic tag. The electronic tag can be read despite the proximity of the metallic part and the electronic tag.

The electronic tag antenna advantageously has a width, measured in the direction of the thickness of the metallic part, greater than the thickness of the edge of the metallic part opposite which the antenna is positioned.

The product as outlined above advantageously comprises said electronic tag on one of its four smallest sides.

According to a further aspect of the invention, a rack comprises means to read electronic tags comprising at least one antenna in at least one of wall of said rack and shelves supporting products as outlined above.

The reading means advantageously comprise a plurality of antennas and electronic signal generation circuits adapted to successively control the generation of electromagnetic fields by different sets of antennas.

Thanks to these arrangements, antennas oriented along different axes, which can be orthogonal to one another, can be read successively.

Advantages, aims and special features of this rack are similar to those of the product as outlined above.

Various aspects of this invention, their main characteristics and their special characteristics may be combined to form an efficient product identification system.

### BRIEF DESCRIPTION OF THE DRAWINGS

Other advantages, aims and features of this invention will appear on reading the following description, given for a non-limiting explanatory purpose and referring to the attached drawings in which:

FIG. 1 is a diagrammatic representation of a first mode of realization of a rack according to this invention;

FIG. 2 is a diagrammatic representation of a second mode of realization of a rack according to this invention;

FIG. 3 is a diagrammatic representation of a first shape of antenna incorporated in a rack illustrated in FIG. 1 or 2;

FIG. 4 is a diagrammatic representation of a second shape of antenna incorporated in a rack illustrated in FIG. 1 or 2;

FIG. 5 is a diagrammatic representation of a third shape of antenna incorporated in a rack illustrated in FIG. 1 or 2;

FIG. 6 represents a product especially adapted to be stored in a rack as illustrated in FIG. 1;

FIG. 7 represents, as a logic diagram, the operation of a rack as illustrated in FIG. 1 or 2;

FIG. 8 represents a information processing system according to this invention and comprising a plurality of racks as illustrated in FIG. 1 or 2 and

FIG. 9 represents a flowchart showing the operation of the information processing system illustrated in FIG. 8.

### DETAILED DESCRIPTION

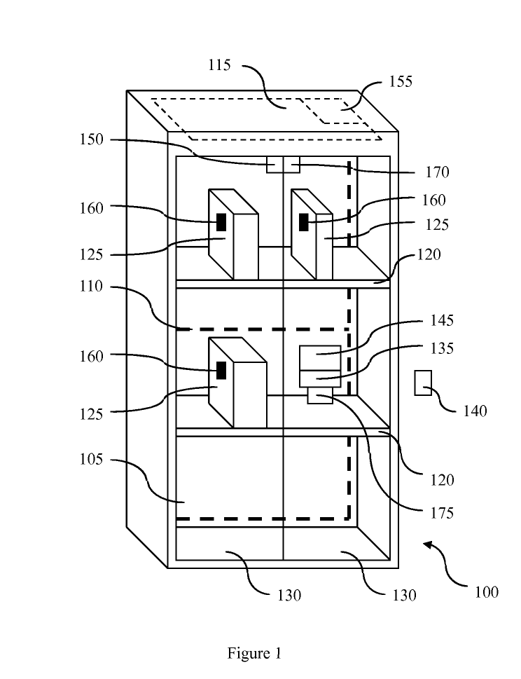

FIG. 1 shows a rack 100 comprising, in or on its back wall 105, an antenna 110, in its upper part, electronic circuits 115, shelves 120 supporting products 125 equipped with electronic tags 160, an electric lock 150, a communication means 155, two doors 130 of which one supports a reader 135 to read an identification card 140 and a display 145, a door closure sensor 170 and an emergency opening button 175.

The rack 100, the shelves 120 and the doors 130 are made from rigid materials, for example wood, glass or plastic.

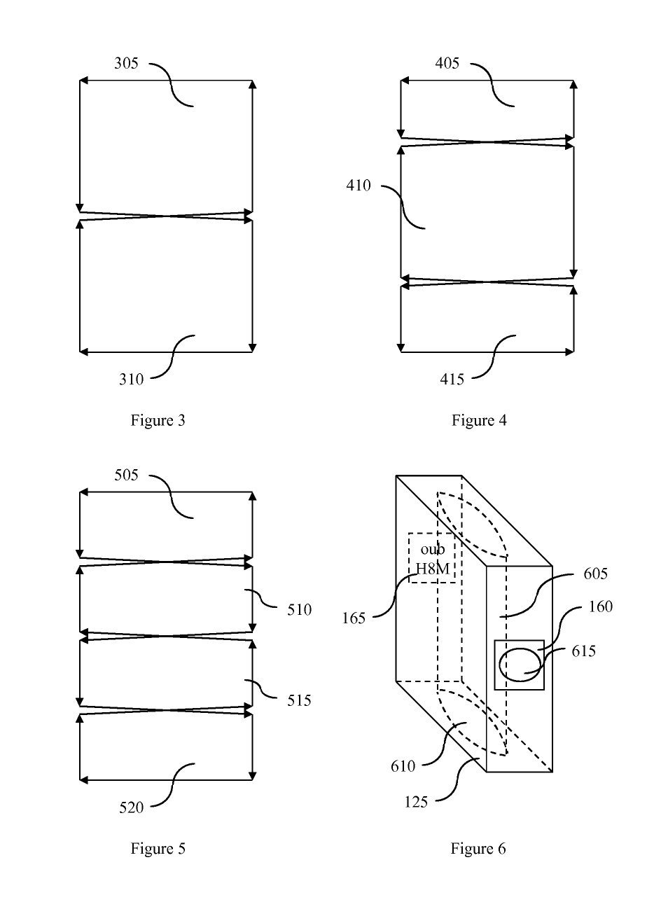

The antenna 110 is connected to the back wall 105, for example by gluing, stapling or inclusion. The antenna 110 may have one of the antenna shapes illustrated in FIGS. 3 to 5.

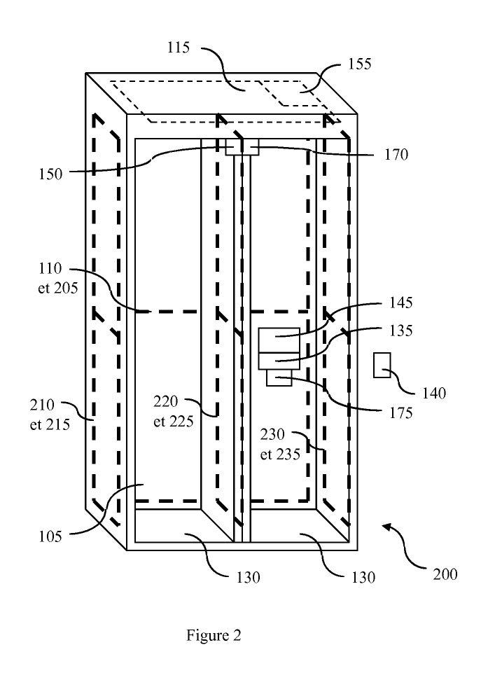

The electronic tags 160 and the electronic circuits 115 are of type known in the field of radio frequency identification (RFID). They comprise, in a known manner, a signal generation circuit adapted to successively generate signals for each antenna or set of antenna incorporated in the rack (see also FIG. 2) and a circuit for reception of signals modulating said magnetic field.

The electronic circuits 115 may comprise, for example, a processor and circuits specific to the field of RFID electronic tags. These are adapted to supply to the antenna 110, at times predetermined according to the closure of the doors 130, a signal enabling generation an electromagnetic field. This electromagnetic field is used to power the electronic tags 160 and transmit messages, requests or instructions to the tags 160. The electronic circuits 115 are also adapted to detect the signals transmitted by the electronic tags 160, by modulation of the magnetic field transmitted by the antenna 110, to process these signals, to identify the electronic tags and to transmit these identifiers to the communication means 155.

The electronic circuits 115 are also adapted to process the signals from the card reader 135 to identify a user and, to control the operation of the electric lock 50, detect the closure of the doors via the sensor 170 and control the contents of the display 145.

The electronic circuits 115 are also adapted to unlock the electric lock 150 when the emergency opening button 175 is pressed.

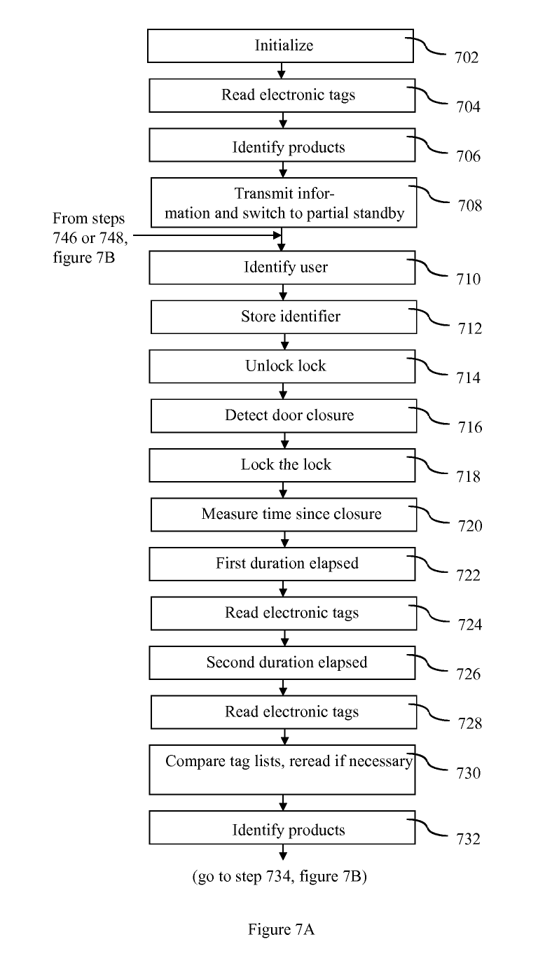

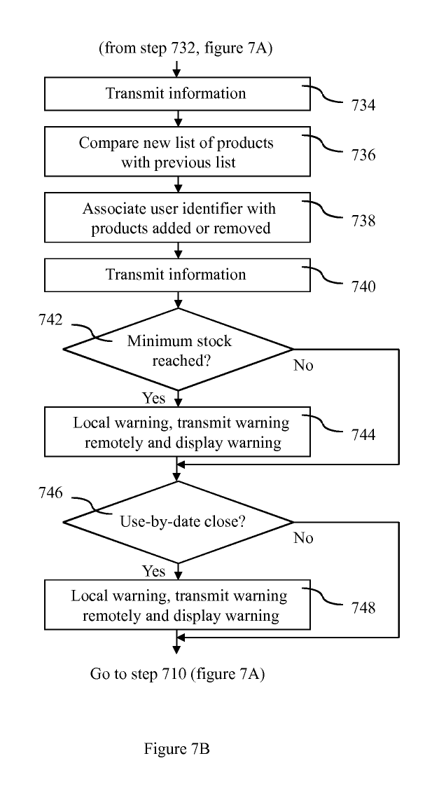

The operation of the electronic circuits 115 is detailed with reference to FIG. 7.

The electric lock 150 is of known type. It is used to lock the doors 130. The communication means 155 allows remote communication with a computer, a server or a information processing system comprising a network, according to known techniques, on wired or wireless support. The communication means 155 may comprise, for example, a modem.

The identification card 135 reader 140 is, for example, of type known in the field of radio frequency identification. In this case, each card 140 comprises a transponder, or electronic tag and the reader 135 comprises an antenna for transmission and reception of magnetic fields, which are modulated so as to exchange data required to identify the cards 140.

As a variant, the reader 135 may be replaced by a biometric identification device of known type, to identify the users accessing the content of the rack 100.

The display 145 is of known type, for example a Liquid Crystal Display (LCD screen) and used to display visible messages to users, for example instructions for their identification, for the positioning of products 125 in the rack 100 and to display warnings if the number of products of a given reference reaches a predetermined value or if one of the products is approaching its use-by-date.

The door closure sensor 170 is of known type, for example dry contact or Hall effect type. It is preferably incorporated in the electric lock 150.

Preferably, when the back wall supports an antenna, arrangements are made so that the electronic tags cannot be placed in the immediate vicinity of this antenna. For example, the back wall in front of each antenna is made slightly thicker, projecting into the rack.

FIG. 2 shows, in a rack 200, the same elements as in FIG. 1, the shelves and the products not being shown for clarity reasons, as well as an antenna 205, in or on the back wall 105 of the rack 200, and antennas 210, 215, 220, 225, 230 and 235, placed two by two in or on the side walls 240 and 245 and central wall 250 of the rack 200. In this case, the electronic circuits 115 are adapted to multiplex the uses of the antennas to successively query the electronic tags 160 whose antennas are positioned according to orthogonal axes.

FIG. 3 shows that a first shape of antenna 300 incorporated in a rack illustrated in FIG. 1 or 2 consists of a figure-8, i.e. two coplanar loops 305 and 310, the conductor forming this antenna going alternately through one or the other of the two loops, with opposite directions of rotation. In this figure, only one coil has been represented, it being understood that the antenna actually comprises a large number of superimposed coils.

Consequently, when the current flows through the two coplanar loops, in one of the loops it flows in the clockwise direction and, simultaneously, in the other loop it flows in the anticlockwise direction. This configuration generates an electromagnetic field over an extended volume near the back wall 105 of the rack.

FIG. 4 shows that a second shape of antenna 400 incorporated in a rack illustrated in FIG. 1 or 2 consists of three coplanar loops 405, 410 and 415, the conductor forming this antenna going alternately through the three loops, with directions of rotation alternately clockwise and anticlockwise. In this figure, only one coil has been represented, it being understood that the antenna actually comprises a large number of superimposed coils.

Consequently, when the current flows through the three coplanar loops, in at least one of the loops it flows in the clockwise direction and, simultaneously, in at least one other loop it flows in the anticlockwise direction. This configuration generates an electromagnetic field over an extended volume near the back wall 105 of the rack.

FIG. 5 shows that a third shape of antenna 500 incorporated in a rack illustrated in FIG. 1 or 2 consists of four coplanar loops 505, 510, 515 and 520, the conductor forming this antenna going alternately through the four loops, with directions of rotation alternately clockwise and anticlockwise. In this figure, only one coil has been represented, it being understood that the antenna actually comprises a large number of superimposed coils.

Consequently, when the current flows through the four coplanar loops, in two of these loops it flows in the clockwise direction and, simultaneously, in the other two loops it flows in the anticlockwise direction. This configuration generates an electromagnetic field over an extended volume near the back wall 105 of the rack.

In the case of the rack illustrated in FIG. 2, for example, the back wall supports both an antenna as illustrated in FIG. 3 and an antenna as illustrated in FIG. 4 and each side or central wall supports an antenna as illustrated in FIG. 3. The inventors discovered, in fact, that this configuration covered the entire interior volume of the rack 200 without leaving any dead areas, with the electromagnetic fields successively transmitted by the various antennas.

FIG. 6 shows a product 125 comprising a paper label 165 and the electronic tag 160. The product comprises a metallic part 610 (in this case a metallic or metalized bag) which is thin, in other words of thickness less than one quarter of its largest dimension, on at least one of its edges 605. The electronic tag 160 has an antenna 615 which is positioned substantially perpendicular to a thin edge of the metallic part 610.

The antenna 615 preferably has a width, measured in the direction of the thickness of the metallic part 610, greater than the thickness of the edge 605 of the metallic part opposite which the antenna is positioned.

The inventors have discovered that, with these characteristics, the electronic tag could be read despite the proximity of the metallic part and the electronic tag.

In FIG. 6, the product 125 has the shape of a rectangular parallelepiped and comprises the electronic tag on one of its four smallest sides. The product 125 also comprises a paper label 165 positioned on a side of the product opposite the side of the product bearing said electronic tag. In this case, the paper label 165 shows the reference “duo M8H”.

As a variant, the paper label 165 is positioned on one side of the product adjacent to a side of the product bearing said electronic tag 160 on one of its small sides.

Consequently, when the user stores the product 125, in a stack or vertically in the rack 100 or 200, he is encouraged to position it so that its paper label 165 is visible. Due to this position, the electronic tag 160 is positioned towards the back wall of the rack or towards one of its shelves, allowing the electronic tags 165 to be read by an antenna positioned on or in the back wall or a shelf, respectively.

The inventors discovered, in fact, that with this configuration:

the user could read the text shown on the paper label 165, without moving the product 125, when the rack doors 130 are open or through these doors 130 when they are transparent, and

the electronic tags 160 were positioned near to and opposite the antenna supported by the back wall 105 of the rack.

When the product 125 is flat, for example with a thickness of 10 mm to 12 mm, the electronic tag 160 preferably comprises an elongated antenna 615, for example measuring 8 mm×80 mm.

As show in FIG. 7, an initialization step 702 is first carried out, during which associations are defined between:
electronic tag identifiers and product references,
electronic tag identifiers and product use-by-dates,
minimum numbers of products of each reference below which products with this reference must be reordered and
card identifications with user identifications.

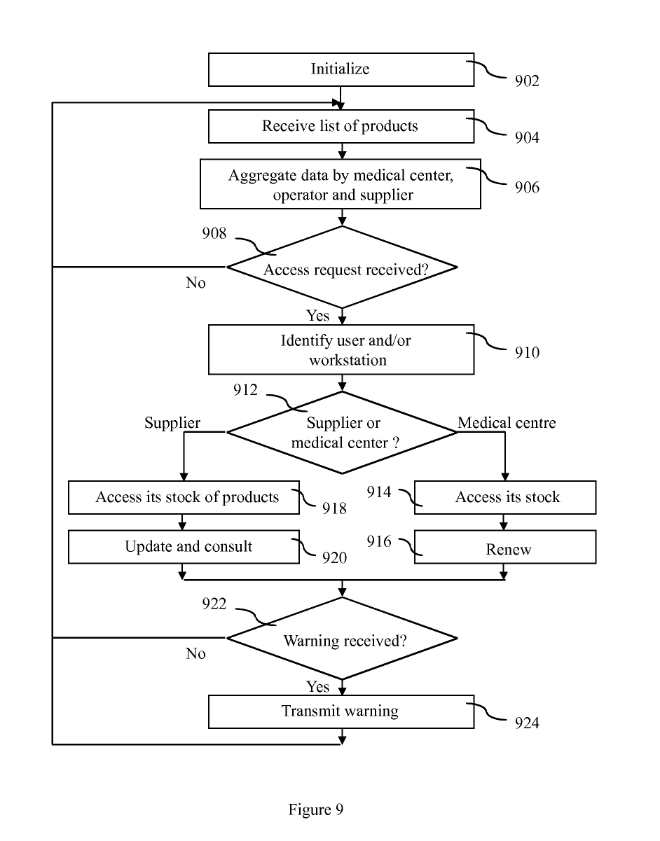

This step 702 can be carried out by reading data in a local and/or remote database, as indicated with reference to FIG. 9.

The rack circuits then perform a first read of the electronic tags present in the rack by successively generating magnetic fields on the various sets of antennas incorporated in the rack, step 704, associate them with product references, step 706, transmit this information remotely, step 708, and go into standby while leaving the identification card 140 reader 135 switched on and displaying, on the display, the rack use instructions.

When a user comes to open the rack, he is identified, step 710, his identifier is stored, step 712, and the rack lock is unlocked, step 714.

When the rack door closure sensor indicates that the doors are closed, step 716, the lock is locked, step 718, and the time which has elapsed since the doors were closed is measured, step 720.

When this duration reaches a first predetermined value, for example ten seconds, step 722, the electronic tags of the products present in the rack are read, step 724, by successively using the rack antennas.

When the time which has elapsed since the rack was closed reaches a second predetermined value, for example one minute, step 726, the electronic tags of the products present in the rack are read, step 728, by successively using the rack antennas.

The list of identifiers obtained during steps 724 and 728 are then compared and, if they are different, additional reads of the electronic tag identifiers are carried out, at predetermined time intervals, for example one minute between two reads, until three successive reads give the same list, step 730.

The electronic tag identifiers are then associated with product references, step 732, and this information is transmitted remotely, step 734.

The list of products present is then compared with the list of products previously present, step 736, and the identification of the user who opened the rack is associated with the references and identifiers of the products which have been added to or removed from the rack, step 738, and this information is transmitted remotely, step 740.

During a step 742, a check is then carried out to determine, for one or more product references, whether the number of products present in the rack is less than or equal to a predetermined value. If yes, during a step 744, a local warning is triggered, this information is transmitted remotely and the references of the missing products are shown on the display.

Then, if the result of step 742 is negative or after step 744, during a step 746, a check is carried out to determine whether the use-by-date of at least one product present in the rack lies within a future of predetermined duration, for example one month. If yes, during a step 748, a local warning is triggered, this information is transmitted remotely and the references of the products concerned are shown on the display.

Then, if the result of step 746 is negative or after step 748, the rack circuits go into standby while leaving the identification card 140 reader 135 switched on and displaying, on the display, the rack use instructions, before returning to step 710.

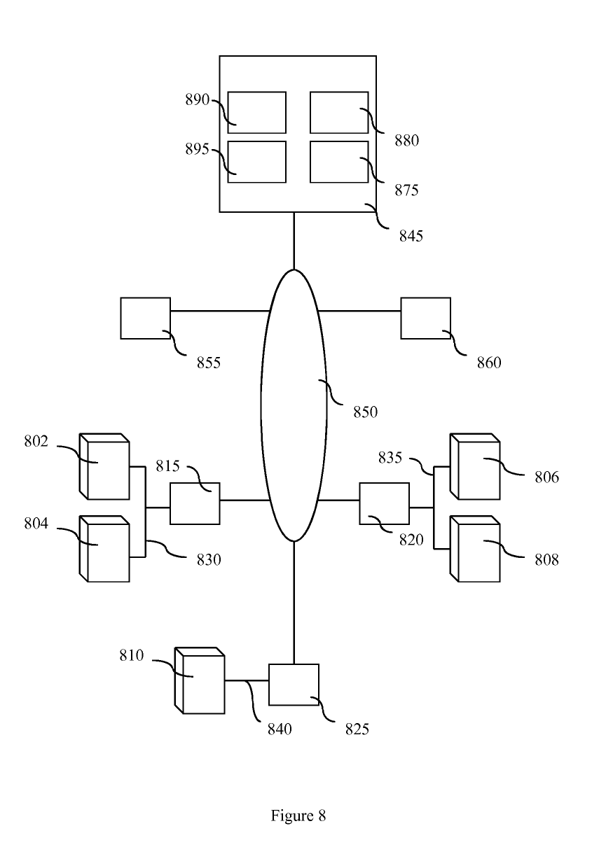

FIG. 8 shows a information processing system 800 comprising a plurality of racks 802 to 810, as illustrated in FIG. 1 or 2 and connected together and to local workstations 815, 820 and 825, by local networks respectively 830, 835 and 840, a server 845 connected to said local networks, by an external network 850 and external workstations 855 and 860 connected, via the external network 850, to the server 845.

The workstations 815, 820, 825, 855 and 860, as well as the server 845 are of known type and each comprises a microprocessor and communication means, for example a modem, enabling them to communicate with the networks to which they are directly connected.

The local workstations implement several user interfaces. A first user interface is used to display the inventory of products present in the various racks of the product user center and, possibly, to launch a read of all the tags on the products present in the rack to check the inventory, for example before a medical operation. This user interface can also be used to access the history of previous inventories.

A second user interface is used to manage automatic renewals and transmit them to the server which forwards them to the suppliers concerned. This restocking can be carried out at fixed times, for example at the end of the working day to avoid renewing a product which is put back in a rack after having been removed, for example in preparation for surgery.

A third user interface is used to assign a complex meaning to an identification card, for example assignment of the products which will be taken from a rack with this card in a specific time interval, to an operating theatre, a patient, a user or a doctor. This assignment allows management of the products consumed during an operation and their invoicing, it being understood that the products put back later into one of the racks, identified by their electronic tags, are recredited to the stock of products.

The external network 850 is, for example, the Internet.

In addition, the server 845 comprises a database 875, means of selective access 880 to the database by the workstations 815, 820, 825, 855 and 860, a warning computer program 890 and a monitoring computer program 895.

The database 875 contains information concerning the products contained in the racks 802 to 810.

The workstations 855 and 860 are implemented by suppliers of products likely to be stored in racks, preferably equipped with paper labels and electronic tags placed on opposite sides of these products.

The workstation 815 and the racks 802 and 804 are located in a first product user center and contain products from suppliers implementing the workstations 855 and 860.

The workstation 820 and the racks 806 and 808 are located in a second product user center and contain products from suppliers implementing the workstations 855 and 860.

The workstation 825 and the rack 810 are located in a third user center and contain products from suppliers implementing the workstations 855 and 860.

The means of selective access 880 to the database are of known type, for example authentication software (for example with user name and password or with card or biometric recognition) or signature software and are adapted to allow each product user center to access its own stock of products contained in the racks 802 to 810, irrespective of the product suppliers.

The means of selective access 880 are also adapted to allow each supplier to access, for all product user centers, the stock level, in the racks 802 to 810, of its own products.

The warning computer program 890 is adapted to trigger warnings when a minimum number of products of a particular reference has been reached in the stock of a product user center. This warning can be used to increase the number of products to be renewed to avoid further warnings.

The monitoring computer program 895 is used to produce a sales report for each supplier, giving a summary of the references by product user center and/or by territory.

Since each workstation of a product user center can be connected by the Internet to the server 845, it can be identified and receive information concerning the products in stock, i.e. entering a rack or leaving a rack in the product user center concerned. Each workstation of a product user center can also consult the delivery delays for the products stored in order to manage their renewal.

As shown on FIG. 9, an initialization step 902 is carried out to initialize the various computer devices, during which the database of the product references and suppliers, and the means of authenticating the users and/or the various workstations likely to access the database, are created.

Then, during a step 904, each rack supplies a first list of products it contains, this list being automatically renewed each time the doors of these racks are closed and completed by warnings and user identifications, as explained previously.

During a step 906, the server aggregates the data received by product user center, by supplier and by user.

During a step 908, the server determines whether a request to access the database has been received. If not, return to step 904. If the result of step 908 is positive, during a step 910, the user and/or the workstation attempting to access the database are identified.

If the identification fails, return to step 904. If the identification succeeds, during a step 912, a check is carried out to determine whether the user and/or the workstation attempting to access the database is a product user center workstation or a supplier workstation.

If it is a product user center, access is allowed to all its own stock of products contained in the racks of this product user center, irrespective of the product suppliers, step 914.

It is also allowed, step 916, to renew products with the suppliers, in which case the renewal request is sent to the suppliers concerned. The product user center therefore selects, in the database, the product references and quantities to renew the stock, the renewal forms being automatically distributed between the suppliers of the references concerned.

If, during step 912, a supplier is found to be accessing, during a step 918, this supplier is allowed to access, simultaneously for all the product user centers, the stock level, in said racks, of its own products.

The supplier is also allowed, step 920, to update its product references, prices and delivery delays and to consult the renewal forms sent to it. The server can therefore be used to produce a sales report for each supplier, giving a summary of the references by product user center and/or by territory, according to known techniques.

After step 916 or 920, a check is carried out to determine whether a warning has been received from a rack, step 922, and, if yes, this warning is transferred to the workstation of the product user center concerned, step 924. Then, if the result of step 922 is negative or after step 924, return to step 904.

As can be seen from the above example, there is a significant improvement over the existing techniques by providing an installation which can be used to manage simply and efficiently the stock of medical equipment in the product user centers and to manage the flow of equipment between the suppliers and these product user centers while allowing the suppliers to manage their stock stored in each product user center. This equipment may be disposable equipment or equipment that can be recycled, in particular equipment used for the fitting of some prostheses.

1. A product having the shape of a rectangular parallelepiped comprising:
at least one metallic part with at least one narrow edge;
an electronic tag having an antenna positioned substantially perpendicular to a narrow edge of said at least one metallic part; and
a paper label positioned on at least one of the following sides of the product: (i) a side opposite to a side of the product bearing said electronic tag, and (ii) a side of the product adjacent to a side of the product bearing said electronic tag on one of its small sides.

2. A product as claimed in claim 1, the electronic tag antenna having a width, measured in the direction of the thickness of the metallic part, greater than the thickness of the edge of the metallic part opposite which the antenna is positioned.

3. A product as claimed in claim 1 comprising said electronic tag on one of its four smallest sides.

4. A rack comprising:
means for reading electronic tags comprising at least one antenna in at least one wall of said rack; and
shelves supporting products having the shape of a rectangular parallelepiped comprising:
at least one metallic part with at least one narrow edge;
an electronic tag with one antenna positioned substantially perpendicular to a narrow edge of said metallic part; and
a paper label positioned on at least one of the following sides of the product: a side opposite to a side of the product bearing said electronic tag, and a side of the product adjacent to a side of the product bearing said electronic tag on one of its small sides.

5. A rack as claimed in claim 4, wherein the reading means comprise a plurality of antennas and electronic signal generation circuits adapted to successively control the generation of electromagnetic fields by different sets of antenna.
